(19) United States
(12) Patent Application Publication
(10) Pub. No.: US 2008/0189196 A1
(43) Pub. Date: Aug. 7, 2008

(54) Healthcare exchange

(76) Inventor: Anuthep Benja-Athon, New York, NY (US)

Correspondence Address: ANUTHEP BENJA-ATHON, 210 E 36TH ST., NEW YORK, NY, 10016, US

(21) Appl. No.: 12/080,433

(22) Filed: Apr. 3, 2008

Related U.S. Application Data
(63) Continuation-in-part of application No. 12/072,097, filed on Feb. 25, 2008.
Application No. 12/072,097 is a continuation-in-part of application No. 12/069,409, filed on Feb. 11, 2008.
Application No. 12/069,409 is a continuation-in-part of application No. 11/059,088, filed on Feb. 16, 2005.
Application No. 11/059,088 is a continuation-in-part of application No. 11/344,485, filed on Feb. 1, 2006.
Application No. 11/344,485 is a continuation-in-part of application No. 11/293,689, filed on Dec. 5, 2005.
Application No. 11/293,689 is a continuation-in-part of application No. 11/242,461, filed on Oct. 4, 2005.
Application No. 11/242,461 is a continuation-in-part of application No. 11/074,236, filed on Mar. 7, 2005.
Application No. 11/074,236 is a continuation-in-part of application No. 11/114,763, filed on Apr. 27, 2005.

(51) Int. Cl. G06Q 50/00; G06F 17/30; G06Q 10/00

(52) U.S. Cl. 705/30; 707/104.1; 705/2; 707/E17.009

(57) ABSTRACT

A method for physicians, patients and health-care buyers to control their health-care resources wherein the uses of data on health-care services generated by the physicians and same or similar data and relating monetary values in the databases and computer programs in a network of computers and servers are used to generate and insert data on payments and disbursements of the resources which are inserted into and related in the databases and are viewable and monitored by the above people.

This application is a continuation-in-part of Ser. No. 12/072,097 entitled A method of empowering owners of health-care resources filed Feb. 25, 2008, a continuation-in-part of Ser. No. 12/069,409 entitled the Filing of health and health-care data filed Feb. 11, 2008, a continuation-in-part of Ser. No. 11/059,088 entitled The consumers-buyers-physicians-directed health-care filed Feb. 16, 2005, a continuation-in-part of Ser. No. 11/344,485 entitled Physicians-patients-health-care-buyers accounting system filed Feb. 1, 2006, a continuation-in-part of Ser. No. 11/293,689 entitled System of conserving health-care buyers' resources, a continuation-in-part of Ser. No. 11/242,461 entitled A perfect system of compensations for physicians filed Oct. 4, 2005, a continuation-in-part of Ser. No. 11/074,236 entitled A system of management of health-care resources filed Mar. 7, 2005 and a continuation-in-part of Ser. No. 11/114,763 entitled A System of Influencing Health-Care Utilizations filed Apr. 27, 2005 which are pending.

### FIELD OF INVENTION

A method of controlling health-care resources by physicians, patients and health-care buyers.

### BACKGROUND OF THE INVENTION

The current health-care system conceived and supported by the archaic system widely use in America is inefficient and, over the decades, has grown into an even more inefficient system which degrades the quality of health-care for people, hinders and impedes the health-care progresses and advancements, increase costs for people, keeps health-care costs high and escalating the health-care costs, impose emotional, physical and financial stresses on physicians, patients and companies and corporations, lowers the standard of living and quality of life and, in tangible terms, wastes hundreds of billions of dollars per annum. Physicians, patients, companies, corporations, Congress, government—alone or combined with vast resources—have heretofore neither know-how nor means to free themselves left alone tackle these crises they are in. Recent enacted laws and regulations have not provide the solution to the enormous crisis being faced by American people. For example, the consumer-directed health-care system such as, but not limited to, the Health Savings Account and the Health Reimbursement Arrangement, since its inception in the 1990's have only several million American participants experiencing numerous severe handicaps.

However, the present invention is a vital component part of the unique and innovative systems and methods for solving said problems and crises of the present patent applicant and his co-inventors and together with the pending inventions of the present patent applicant and his co-inventors contribute to the solution to said problems and crises.

Therefore, the present invention is the unique and innovative anchor for a system of patent-pending means for solving the health-care crises in America wherein physicians, patients and health-care buyers have the one and only means for directly controlling, allocating, accounting and influencing of their resources while reducing or eliminating interferences, hindrances and hundreds of billions of dollars of wastes and losses. The benefits to hundreds of millions of people including physicians, patients and health-care buyers—who are heretofore free from their decades-long and escalating pain and suffering—and the nation are enormously immense.

### SUMMARY OF THE INVENTION

The present invention is a vital linchpin of an innovative health-care system wherein hundreds of millions of physicians, patients and companies take control of their resources to improve the health-care system to benefit themselves and health-care.

The present invention provides a system and a method for physicians, patients and health-care buyers to control their health-care resources wherein the uses of data on health-care services provided to patients generated by the physicians and the uses of same, similar or equivalent data and relating monetary values in the databases and a computer program means for using said data and to generate and insert data on payments and disbursements representing transfers of said resources among accounts of said physicians, patients and buyers into the databases and to generate derivatives of said data and to display said data and their derivatives to and be monitored by the above people in a network of computers and computer servers.

### DESCRIPTION OF THE PREFERRED EMBODIMENTS

The present invention is a system and a method for physicians, health-care consumers and buyers to control their health-care resources and either reduce or eliminate the interferences and hindrances of and tremendous wastes and losses per annum present in the current health-care system.

The present invention provides the use of data on health-care services provided to the patients by said physicians which are components of the health and health-care data and information on said patients generated by said physicians and input into computers and computer server or servers and the same or equivalent data on health-care services and relating monetary values representing prices or monetary values of said services in the databases in said computer server or servers in a network or networks of said computers and computer servers and a computer program means for using said data on health-care services, said same or equivalent data on health-care services and relating monetary values to effect the generations of data on physicians' accounts comprising data on credits or payments for the health-care services provided to patients by said physicians, data on said patients' accounts comprising data on the disbursements of funds of said patients' accounts relating to said data on said credits or payments and said health-care services and data on health-care buyers' accounts comprising data on the disbursements of funds of said buyers' accounts relating to said data on said credits or payments and disbursements

The present invention is a system and a method of relating data on the credits representing payments and total payments relating to time credited to the physicians' accounts for the health-care services provided to patients by said physicians and data on the debits, deductions or disbursements of patients' and health-care buyers' funds—and fund disbursements and balances relating to time—corresponding to or representing said payments for said services to said physicians by or on the behalf of said patients and by or on the behalf of the health-care buyers in a computer server or computer servers in a network or networks of computers and computer servers.

The present invention provides data on health-care services provided to patients by physicians which are components of the health and health-care data and information on patients generated by physicians and input into the computers in a network or networks of computers and computer servers and the uses of said data on health-care services and the uses of same or equivalent data on health-care services and relating monetary values representing prices or monetary values of said services in the databases in said computer server or servers to effect the insertions of said data into the database or databases comprising the accounts of said physicians comprising data on said credits and payments credited to said physicians and relating to said debits or disbursements, the accounts of said patients comprising data on deposits and said debits or disbursements relating to said payments and the accounts of the health-care buyers comprising data on deposits and said debits and balances of funds relating to said payments or disbursements.

One of the preferred embodiments of the present invention—a unique innovation of the present invention and supports by the unique and innovative computer programs created by the present invention physician applicant—is the unique and innovative uses, processing and applications of the data on the health-care services—components of the health and health-care data and information on patients generated by physicians and taught in the pending applications of the present invention applicant and his other earlier co-applicants—comprise main words, terms, phrases and sentences in the data on health-care services and the same or equivalent data on health-care services and relating monetary values representing prices or costs of said services in the database or databases and the relationship of said data on health-care services and said same or equivalent data on health-care services in the database or databases.

In other words, although the general trends of the generations of said data on health-care services by thousands of physicians in about 80 medical and surgical specialties are for said physicians to predictably use means for producing or generating common words, terms, phrases and sentences—based on the common medical and surgical structures of words, terms, phrases and sentences use by physicians in their practices—matching same, equivalent or similar data on and data structures of health-care services created in the database or databases. However, the present invention covers said data on health-care services in order to compensate for any deviations from said trends such as, but not limited to, variations including errors in and to match said data on health-care services generated by said physicians to said same or equivalent data on health-care services and relating monetary values representing prices or costs of said services in the database or databases to achieve the goals and objectives of the present invention, the present invention necessarily provides the innovative computer programs which process or manipulate said data on health-care services generated by physicians to conform or match to said same or equivalent data on health-care services and relating monetary values representing prices or costs of said services in the database or databases.

To account for and compensate for the variations and errors in the data on health-care services generated by physicians, first, the present invention provides computer program means for compensating and correcting errors in said data. Second, the present invention provides same or equivalent data as said data on health-care services comprises words, terms and phrases in the database or databases so that the computer programs infra designed by the present patent applicant can achieve the processes using matches of said processed data and said same or similar data in the databases described herein.

The data on the health-care services comprise very large data on categories such as, but not limited to, Evaluations, Treatments, Procedures, Surgeries, Diagnoses, Medications and Laboratories and Tests which are used by physicians in about 80 medical and surgical specialties or practices. Said Evaluations comprise a list of items such as, but not limited to, consultations, visits, examinations and preceding modifiers such as, but not limited to, simple, routine, brief, intermediate, complex and comprehensive. Said Treatments, Procedures, Surgeries and Diagnoses each of which comprises an even longer list of items commonly used by physicians in about 80 medical and surgical specialties as described in the earlier pending patent applications of the present patent applicant and his co-applicants. For example, in Treatments such as, but not limited to, incision drainage, trigger point injection, bursa injection, in Surgeries such as, but not limited to, cholecystectomy, gall bladder removal, knee arthroscopy, and endoscopy. Prices or costs per item.

Further to supra, said computer programs further account and compensate for the variations of said words, terms, phrases and sentences such as, but not limited to, the variations in the numbers of words, terms, phrases and sentences, the relative positions of said words, terms and phrases, the relative positions of words and terms in sentences, and the variations of lengths and sentences, and also errors associating with words, terms, phrases and sentences in said data generated and input by said physicians. Furthermore, first, said computer programs also find and manipulate words representing sidedness in said data on health-care services associate with said main words, terms, phrases and sentences such as, but not limited to, words “left”, “right”, “both”, “bilateral”, “ipsilateral”, “contralateral” and “multiple”, etc. to match said main words, terms, phrases with same or equivalent words, terms and phrases relating to monetary values infra in said databases. For example, a phrase in said data on health-care services generated and in put by a physician may be “left knee arthroscopy” which are processed by said computer programs to be used as “knee arthroscopy” matching same or equivalent “knee arthroscopy” and “knee” “arthroscopy” in said database or databases.

Furthermore, second, said computer programs also find and manipulate the prepositions such as, but not limited to, “and”, “by”, “in” , “on”, “with”, “for”, “the”, “a”, “an” and “of”, etc., present in said data on health-care services. Said computer programs also find and manipulate plurals and certain alphabetical endings of said words, terms, phrases and sentences in said data on health-care services in order to enable the matches of said data on health-care services with the same or equivalent data on health-care services and relating monetary values representing prices or monetary values of said services in the database or databases. For example, a phrase in said data on health-care services generated and in put by a physician may be “the left knee arthroscopy” or “the arthroscopy of the left knee” which are processed by said computer programs to be used as “knee arthroscopy” and “arthroscopy” “knee” matching same or equivalent “knee arthroscopy” and “knee” “arthroscopy” in said database or databases.

Furthermore, third, said computer programs also find and manipulate plural endings and plurals of words and terms and the words and terms in phrases and sentences to match said same or equivalent singulars—word singulars and term singulars—in said databases. For example, a phrase in said data on health-care services generated and in put by a physician may be “surgeries of bilateral knees” which are processed by said computer programs to be used as “surgery knee” matching same or equivalent “surgery knee” and “knee” “surgery” in said database or databases. In these instances, said computer programs are created to know to price a knee surgery and to price yet another price accounting for surgeries of two knees, etc.

Moreover, said computer programs scan and match said words, terms and phrases with same, similar, equivalent and modified-but-equivalent words, terms and phrases in the database or databases which are related to the data of prices or costs.

Said unique innovative computer program means described herein—whose programs and source codes earlier filed with the Library of Congress, Office of the Copyrights in Washington, D.C.—of the present patent applicant are based on SQL such as, but not limited to, the Microsoft SQL and the common computer language PHP or the like or the equivalence which manipulate, process, insert, store and use the vital data present in said words, terms, phrases and vital words and terms and data in said sentences representing health-care services in the data on health-care services, health and health-care data and information on patients generated by physicians and predominantly and directly input by said physicians into the computers and computer server or servers in said network or networks of computers and computer servers.

Furthermore, said innovative computer programs also effect the scanning and matching said vital data, words and terms with the uniquely created same or similar data on health-care services in the database or databases encompassing data on health-care services of about 80 medical and surgical specialties or practices so that said data match, are same or similar. Said innovative computer programs insert of said data on health-care services and the outcomes of said processes and relating monetary values into said physicians' accounts, and patients' and health-care buyers' accounts in said database or databases. Furthermore, said computer programs also effect the insertions of said data and data on the credits representing payments of said services to said physicians and the data on the debits of funds or disbursements representing said payments of said services by said patients and health-care buyers into the database or databases comprising the accounts of said physicians comprising data on said credits and payments credited to said physicians by or on the behalf of said patients and by or on the behalf of the health-care buyers and relating to said debits or disbursements, the accounts of said patients comprising data on deposits and said debits or disbursements relating to said payments and the accounts of the health-care buyers comprising data on deposits and said debits and balances of funds relating to said payments or disbursements in said computer server or servers.

The billing rates for health-care services represent by the fees and payments for items in the Evaluations, Treatments, Procedures, Surgeries, Diagnoses, Medications and Laboratories and Tests for about 80 medical and surgical specialties such as neurology, orthopaedics, general surgery, etc. can be established as data in the database or databases and frequently added and/or edited.

Furthermore, said computer programs effecting said relations of said data and also—effect the related displays of payments and total payments are viewable and monitored by said physicians and wherein said items of services and related payments, debits and balances are viewable and monitored by said patients and, appropriately, by said health-care buyers.

Said computer programs effecting said relations of said data, furthermore, also effect the feedbacks or exchanges of information such as, but not limited to, disputes, disaccords and the like relating to said credits, payments, debits, disbursements, refunds or reimbursements and balances between physicians, patients and health-care buyers.

Moreover, the present invention provides an innovative method for physicians to correct erroneous entries of said data. This embodiment is achieved by the present invention providing said computer programs for correcting erroneous entries of said data by physicians. For example, errors such as, but not limited to, entries of erroneous data or information or any misspellings or mismatches of said data of health-care services generated by said physicians and data of health-care services in the database or databases may result in the incompletions of said processes or transactions. In these settings, notices are generated to inform said physicians of said deficiencies or defects and said program means permit physicians to correct said errors or reenter correct data and information to fulfill the objectives of the present invention.

It is further understood that further to supra, in addition to said words, terms, phrases and sentences, digits and alphanumerics can and are also used—albeit far less commonly than the uses and applications of said words, terms, phrases and sentences—in said data on health-care services, health and health-care data and information on patients generated by physicians and said data on health-care services relate to same or equivalent data on health-care services and relating monetary values representing prices or monetary values of said services in the database or databases. In this setting, it is understood that the above can be and is adapted to incorporate this variation present in said data and information.

It is understood that the present invention is also able to convert said words, terms, phrases and sentences into corresponding digits and further modify or adapt the database or databases to comprise of digits within the spirit and scope of the claims of the present invention.

The present invention is achieved by the present patent applicant's said innovative computer programs invented by the present patent applicant. Said programs are based on the commercially available computer software (plural), programs and computer languages such as, but not limited to, those made and sold by Microsoft Corporation such as, but not limited to, Microsoft SQL, Visual Studio and .Net, Internet Explorer and browsers and their databases and derivatives, other computer corporations' and companies' programs and languages, databases and their derivatives which are commonly and routinely used or use by computer engineers and programmers such as, but not limited to, PHP, PERL, C languages, etc.

It is understood that—by laws—each patient of individual patients herein can only access and use such as, but not limited to, add and edit, his or her health and health-care data and, under the same setting, only physicians authorized by said patient are permitted and allow access to said patient's confidential health and health-care data and information. Corollary, each patient can view and feedback on the data on health-care services and related payments, disbursements, credits, debits, deductions, disbursements, refunds or reimbursements and balances. Similarly, each physician can also view and feedback on the data on health-care services and related payments and credits and year-to-date and total payments to his or her accounts. Similarly, each company or corporation or health-care buyer can also view and feedback on the disbursements, deductions and balances data pertinent to the company's, corporation's or health-care buyer's account.

It is understood that the preferred embodiments of the present invention enable means greater than the principles intended and supporting the consumer-directed health-care system such as, but not limited to, Health Savings Account and the Health Reimbursement Arrangement and the like wherein health-care consumers and health-care consumers-buyers, health-care buyers and physicians have significant direct total and/or controls, allocations, accounts and influences of their resources and eliminate interferences, hindrances, hundreds of billions of dollars of wastes and losses per annum and pain and suffering caused by or attributable to other parties. The present invention provides the means for health-care consumers, health-care consumers-buyers and/or health-care buyers to pay for said health-care services and to view and monitor and control their health-care resources or monies, credits, funds, payments, disbursements, reimbursements, earning and expense totals and balances and benefits derive from supra.

It is understood that patients are or can be health-care consumers and health-care buyers and employers, companies, corporations and governments are health-care buyers although employers are or can be patients. Health-care providers are physicians and other people who provided health and health-related services to people.

It is understood that the terms health-care, health care and healthcare have the same meaning and application and that the terms computer server and server have the same meaning and application.

It is understood that health-care resources, credits, funds, payments, disbursements, reimbursements, totals, balances, etc. used herein are such as, but not limited to, dollars and cents and other foreign currencies and instruments of payment.

Having described some of the preferred embodiments of the present invention, said embodiments of the present invention can be extended to embody and provide a platform for a barter system or an exchange wherein health and health-care resources produce by, derived from or of physicians can be exchanged or bartered with non-health and non-health-care goods and services produced, derived from or of patients and health-care buyers. This is useful for people and health-care buyers with either no or limited financial resources or unused, excess or over-produced goods and services but has other resources such as, but not limited to, skills, trades or items of value.

Although various preferred embodiments of the present invention have been described, it will be appreciated by those skilled in the art that adaptations and variations may be made without departing from the spirit and the scope of the claims of the present invention.

Claims of the invention:

1. A method of relating data on the credits representing payments credited to the physicians' accounts for the health-care services provided to patients by said physicians by or on the behalf of said patients and by or on the behalf of the health-care buyers and data on the deposits and debits, deductions or disbursements of patients' and health-care buyers' funds corresponding to payments for said services to said physicians by or on the behalf of said patients and by or on the behalf of health-care buyers and the data on health-care services are used to effect the insertions of said data on health-care services and relating monetary values into physicians' accounts, and patients' and health-care buyers' accounts in the database or databases comprising data on said credits and payments credited to said physicians and relating to said debits or disbursements, data on deposits and debits or disbursements and balances relating to said payments of said patients' accounts and data on deposits and said debits and balances of funds relating to said payments or disbursements of said health-care buyers' accounts in a computer server or computer servers in a network or networks of computers and computer servers, wherein said data are derived from the uses of data on said health-care services which are components of the health and health-care data and information on said patients generated by said physicians and input into the computers in said network or networks and the uses of same or equivalent data on health-care services and relating monetary values in the database or databases, wherein said data on health-care services relate to said same or equivalent data on health-care services and relating monetary values representing prices or monetary values of said services, wherein said data on health-care services and related payments and derivatives are viewable and monitored by said physicians, wherein said data on health-care services and related payments, disbursements, balances and derivatives are viewable and monitored by said patients and, appropriately, by said health-care buyers and wherein feedbacks on said data between said physicians and patients are effected for the benefits of said physicians, patients and health-care buyers and wherein erroneous or inaccurate entries of said data by physicians can be corrected by said physicians comprises:
a process of using data on health-care services generated by physicians;
a process of defining category means for relating data in said data on health-care services and same data on health-care services in the database or databases;
a process of defining category means for relating data in said data on health-care services and equivalent data on health-care services in the database or databases;
a process of generating same data as said data on health-care services in the database or databases;
a process of generating similar data as said data on health-care services in the database or databases;
a process of generating equivalent data as said data on health-care services in the database or databases;
a process of processing said data on health-care services generated by physicians;
a process of generating same data as the processed data on health-care services in the database or databases;
a process of generating similar data as the processed data on health-care services in the database or databases;
a process of generating equivalent data as the processed data on health-care services in the database or databases;
a process of generating said data and relating monetary values in the database or databases;
a process of scanning said data on health-care services;
a process of processing said data on health-care services;
a process of matching said data on health-care services with same data in said database or databases;
a process of matching said data on health-care services with similar data in said database or databases;
a process of matching data on health-care services with equivalent data in said database or databases;
a process of matching said processed data on health-care services with same data in said database or databases;
a process of matching said processed data on health-care services with similar data in said database or databases;
a process of matching said processed data on health-care services with equivalent data in said database or databases;
a process of selecting matches of said data on health-care services;
a process of selecting said data and relating monetary values;
a process of inserting said data on health-care services and relating monetary values into said data comprising physicians' accounts in the database or databases;
a process of inserting said data on health-care services and relating monetary values into said data comprising patients' accounts in the database or databases;
a process of creating database or databases comprising data on said credits and payments credited to said physicians;
a process of creating database or databases comprising data said debits, deductions or disbursements;
a process of creating database or databases comprising data on the debits, deductions or disbursements;
a process of relating said data the credits representing payments credited to the physicians' accounts for the health-care services provided to patients by said physicians and said data on the debits, deductions or disbursements of funds representing payments for said services to said physicians from said patients' accounts in the database or databases;
a process of relating said data the credits representing payments credited to the physicians' accounts for the health-care services provided to patients by said physicians and said data on the debits, deductions or disbursements of funds representing payments for said services to said physicians from said health-care buyers' accounts in the database or databases;
a process of storing the outcomes of said processes in the databases;
a process of displaying data on health-care services and related payments and payments to physicians;
a process of displaying data on health-care services and related payments, debits or disbursements and balances to patients;
a process of displaying data on debits or disbursements and balances to health-care buyers;
a process of correcting erroneous or inaccurate entries of said data by physicians; and
a process of feedbacks on the outcomes of said processes between said physicians and patients.

2. A method of using data on health-care services provided to patients by physicians which are components of the health and health-care data and information on patients generated by physicians and input into the computers in a network or networks of computers and computer servers and the same or equivalent data on health-care services and relating monetary values representing prices or monetary values of said services in the databases in said computer server or servers to effect the insertions of data on the credits representing payments of said services to said physicians by or on the behalf of said patients and by or on the behalf of the health-care buyers and the data on the debits or disbursements of funds corresponding to said payments of said services by or on the behalf of said patients and by or on the behalf of the health-care buyers into the database or databases comprising data on said credits and payments credited to said physicians and relating to said debits or disbursements, data on deposits and debits or disbursements and balances relating to said payments of said patients' accounts and data on deposits and said debits and balances of funds relating to said payments or disbursements of said health-care buyers' accounts and to relate said data on the credits representing payments of said services to said physicians and said data on the debits of funds or disbursements representing said payments by said patients and health-care buyers, wherein said data on health-care services relate to same or equivalent data on health-care services and relating monetary values representing prices or monetary values of said services in the databases wherein said data on health-care services are used to effect the insertions of said data on health-care services and relating monetary values into said physicians' accounts, and patients' and health-care buyers' accounts in said database or databases, wherein said data on health-care services and related payments and derivatives are viewable and monitored by said physicians, wherein said data on health-care services and related payments and derivatives are viewable and monitored by said patients and, appropriately, by said health-care buyers and wherein feedbacks on said data between said physicians and patients are also effected for the benefits of said physicians, patients and health-care buyers and wherein erroneous or inaccurate entries of said data by physicians can be corrected by said physicians comprises:
a process of using data on health-care services generated by physicians;
a process of defining category means for relating data in said data on health-care services and same data on health-care services in the database or databases;
a process of defining category means for relating data in said data on health-care services and equivalent data on health-care services in the database or databases;
a process of generating same data as said data on health-care services in the database or databases;
a process of generating similar data as said data on health-care services in the database or databases;
a process of generating equivalent data as said data on health-care services in the database or databases;
a process of processing said data on health-care services generated by physicians;
a process of generating same data as the processed data on health-care services in the database or databases;
a process of generating similar data as the processed data on health-care services in the database or databases;
a process of generating equivalent data as the processed data on health-care services in the database or databases;
a process of generating said data and relating monetary values in the database or databases;
a process of scanning said data on health-care services;
a process of processing said data on health-care services;
a process of matching said data on health-care services with same data in said database or databases;
a process of matching said data on health-care services with similar data in said database or databases;
a process of matching data on health-care services with equivalent data in said database or databases;
a process of matching said processed data on health-care services with same data in said database or databases;
a process of matching said processed data on health-care services with similar data in said database or databases;
a process of matching said processed data on health-care services with equivalent data in said database or databases;
a process of selecting matches of said data on health-care services;
a process of selecting said data and relating monetary values;
a process of inserting said data on health-care services and relating monetary values into said data comprising physicians' accounts in the database or databases
a process of inserting said data on health-care services and relating monetary values into said data comprising patients' accounts in the database or databases
a process of creating database or databases comprising data on said credits and payments credited to said physicians;
a process of creating database or databases comprising data said debits, deductions or disbursements;
a process of creating database or databases comprising data on the debits, deductions or disbursements;
a process of relating said data the credits representing payments credited to the physicians' accounts for the health-care services provided to patients by said physicians and said data on the debits, deductions or disbursements of funds representing payments for said services to said physicians from said patients' accounts in the database or databases;
a process of relating said data the credits representing payments credited to the physicians' accounts for the health-care services provided to patients by said physicians and said data on the debits, deductions or disbursements of funds representing payments for said services to said physicians from said health-care buyers' accounts in the database or databases;
a process of storing the outcomes of said processes in the databases;
a process of displaying data on health-care services and related payments and payments to physicians;
a process of displaying data on health-care services and related payments, debits or disbursements and balances to patients;
a process of displaying data on debits or disbursements and balances to health-care buyers;
a process of correcting erroneous or inaccurate entries of said data by physicians; and
a process of feedbacks on the outcomes of said processes between said physicians and patients.

3. A system of physicians, health-care consumers and buyers controlling health-care resources using data on health-care services provided to the patients by said physicians which are components of the health and health-care data and information on said patients generated by said physicians and input into computers and computer server or servers in a network or networks of said computers and computer servers and the same or equivalent data on health-care services and relating monetary values representing prices or monetary values of said services in the databases in said computer server or servers and a computer program means for using said data on health-care services, said same or equivalent data on health-care services and relating monetary values to effect the generations of data on physicians' accounts comprising data on credits or payments for said health-care services provided to patients by or on the behalf of said patients and by or on the behalf of the health-care buyers, data on said patients' accounts comprising data on the disbursements of funds of said patients' accounts relating to said data on said credits or payments and said health-care services and data on health-care buyers' accounts comprising data on the disbursements of funds of said buyers' accounts relating to said data on said credits or payments and disbursements and the insertions and relating of said data in said databases and a system of feedbacks wherein said data on health-care services and related payments and derivatives are viewable and monitored by said physicians and wherein said data on health-care services and related payments and derivatives are viewable and monitored by said patients and, appropriately, by said health-care buyers, wherein feedbacks on said data between said physicians and patients are also effected in said network or networks of computers and computer servers for the benefits of said physicians, patients and health-care buyers and wherein erroneous or inaccurate entries of said data by physicians can be corrected by said physicians comprises:
data on health-care services generated by physicians;
category means for relating data in said data on health-care services and same data on health-care services in the database or databases;
category means for relating data in said data on health-care services and equivalent data on health-care services in the database or databases;
data on health-care services in the database or databases comprising words, terms and phrases in said data on health-care services generated by physicians;
data on health-care services in the database or databases comprising similar words, terms and phrases in said data on health-care services generated by physicians;
data on health-care services in the database or databases comprising equivalent words, terms and phrases in said data on health-care services generated by physicians;
a computer program means for processing said data on health-care services generated by physicians to conform to said data on health-care services in said database or databases;
a computer program means for using said data on health-care services, said same, similar or equivalent data on health-care services and relating monetary values to effect the generations of said data on physicians' accounts comprising data on credits or payments for said health-care services provided to patients by or on the behalf of said patients and by or on the behalf of the health-care buyers
a computer program means for using said data on health-care services, said same, similar or equivalent data on health-care services and relating monetary values to effect the generations of said data on said patients' accounts comprising data on the disbursements of funds of said patients' accounts relating to said data on said credits or payments
a computer program means for using said data on health-care services, said same, similar or equivalent data on health-care services and relating monetary values to effect the generations of said data on health-care buyers' accounts comprising data on the disbursements of funds of said buyers' accounts relating to said data on said credits or payments and disbursements
a computer program means for generating equivalent data as said processed data on health-care services in the database or databases;
a computer program means for generating said data and relating monetary values in the database or databases;
a computer program means for scanning said data on health-care services;
a computer program means for matching data on health-care services generated by physicians with data on health-care services in said database or databases;
a computer program means for selecting said data on health-care services and relating monetary values;
a computer program means for inserting data on health-care services and relating monetary values into physicians' accounts in the database or databases
a computer program means for inserting data on health-care services and relating monetary values into patients' accounts in the database or databases
a computer program means for creating database or databases comprising data on the credits and payments credited to said physicians;
a computer program means for creating database or databases comprising data on said debits, deductions, disbursements and balances;
a computer program means for relating said credits and payments, debits, deductions, disbursements and balances;
a computer program means for relating data on the credits representing payments credited to the physicians' accounts for the health-care services provided to patients by said physicians and data on the debits, deductions or disbursements of funds representing payments for said services to said physicians from said patients' accounts in the database or databases;
a computer program means for relating said data on the transfers of funds, debits, deductions or disbursements and balances in said patients' and health-care buyers' accounts in the database or databases;
a computer program means for storing the outcomes of said processes in the databases;
a computer program means for displaying data on health-care services and related payments and total payments to physicians;
a computer program means for displaying data on health-care services and related payments, debits and balances to patients;
a computer program means for displaying payments, debits and balances to health-care buyers;
a computer program means for allowing physicians to correct erroneous or inaccurate entries; and
a computer program means for displaying feedbacks on the outcomes of said processes to said physicians and patients.
